(19) United States
(12) Patent Application Publication
(10) Pub. No.: US 2026/0213870 A1
(43) Pub. Date: Jul. 23, 2026

(54) ETHERNET PHY RATE RENEGOTIATION

(71) Applicant: Comcast Cable Communications, LLC, Phildelphia, PA (US)

(72) Inventors: Benny Pruden, Philadelphia, PA (US); Christopher Stone, Philadelphia, PA (US)

(21) Appl. No.: 19/030,783

(22) Filed: Jan. 17, 2025

(51) Int. Cl. H04L 1/00; H04L 47/30

(52) U.S. Cl. CPC H04L 1/0002; H04L 47/30

(57) ABSTRACT

A method described herein comprises setting, by a first computing device, an Ethernet physical layer interface (PHY) rate associated with a network link to a first set of one or more network parameters. The method comprises detecting first environmental information and determining that the first environmental information does not satisfy a first environmental parameter. The method comprises changing, such as decreasing, the Ethernet PHY rate to a second set of one or more network environmental parameter. The method further comprises detecting second environmental information, and determining that the second environmental information satisfies a second environmental parameter. The method may also comprise increasing the Ethernet PHY rate to a third set of one or more network parameters after determining that the second environmental information satisfies the second environmental parameter.

### BACKGROUND

When Ethernet communication technology is exposed to sufficient environmental conditions, such as radio frequency (RF) interference or noise, the Ethernet may experience communication errors.

These and other shortcomings related to Ethernet communication technology are identified and addressed in the disclosure.

### SUMMARY

It is to be understood that both the following general description and the following detailed description are exemplary and explanatory only and are not restrictive. Methods and systems for determination of renegotiating Ethernet PHY rates are described.

The systems and methods described herein relate to monitoring and maintaining the health of Ethernet data traffic, particularly in view of environmental conditions (parameters), such as (RF) radio frequency interference, heat, magnetic fields, static energy, etc. The systems and methods described herein may monitor environmental information, such as RF noise, heat, magnetic fields, static energy, etc. The systems and methods may use telemetry related to Ethernet data traffic and the monitored environmental information to determine any adverse effects of the environmental conditions on the Ethernet traffic. The systems and methods described herein may implement mitigation techniques if the environmental conditions interfere with the Ethernet data traffic.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example environment in which the systems and methods described herein may operate.

FIG. 2 shows an example of an Ethernet packet and frame structure.

FIG. 3 shows an example network link described herein.

FIG. 4 shows an example method for renegotiating an Ethernet PHY rate described herein.

FIG. 5 shows an example method for renegotiating an Ethernet PHY rate described herein.

FIG. 6 shows an example method for renegotiating an Ethernet PHY rate described herein.

The accompanying drawings show examples of the disclosure. It is to be understood that the examples shown in the drawings and/or discussed herein are non-exclusive and that there are other examples of how the disclosure may be practiced.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

The present disclosure relates to negotiating a lower Ethernet physical layer interface (PHY) rate when an error affecting Ethernet data traffic is detected, and periodically attempting to renegotiate back to a higher PHY rate in case noise and/or interface causing the error is no longer present.

Disclosed herein are systems and methods for increasing an Ethernet transmit buffer, in addition to reducing the PHY rate, in response to detecting an error affecting Ethernet data traffic. Increasing the Ethernet transmit buffer may help because Ethernet transmission may get delayed and/or reduced during a time of impairment of Ethernet data traffic.

Disclosed herein are one or more interfaces (radio frequency (RF) interfaces) configured to detect a presence of excessive RF interference. Interfaces may be or comprise antenna or sensors such as an electromagnetic sensor capable of detecting electrostatic discharges, lightening and other electrical occurrences that may exist in an environment. The one or more RF interfaces may comprise an antenna, such as a Wi-Fi antenna, a Bluetooth antenna, etc. Excessive RF interference may result from RF radiating devices being within close proximity of the Ethernet interfaces and/or cables, as an example, a cellphone streaming audiovisual content over a cellular network may be sitting on top of an Ethernet switch, etc. Excessive RF interference may penetrate an Ethernet cable and cause an Ethernet PHY error. The one or more RF interfaces may be used to help predict Ethernet PHY errors. In response to a predicted Ethernet PHY error, the PHY rate may be reduced and/or the Ethernet transmit buffer may be increased. In addition to RF interfaces, the systems and methods described herein may use other components to detect excessive environmental conditions, such as heat, magnetic fields, etc. A thermometer and/or a thermal image sensor may be used to detect excessive heat. A magnetometer may be used to detect excessive magnetic fields.

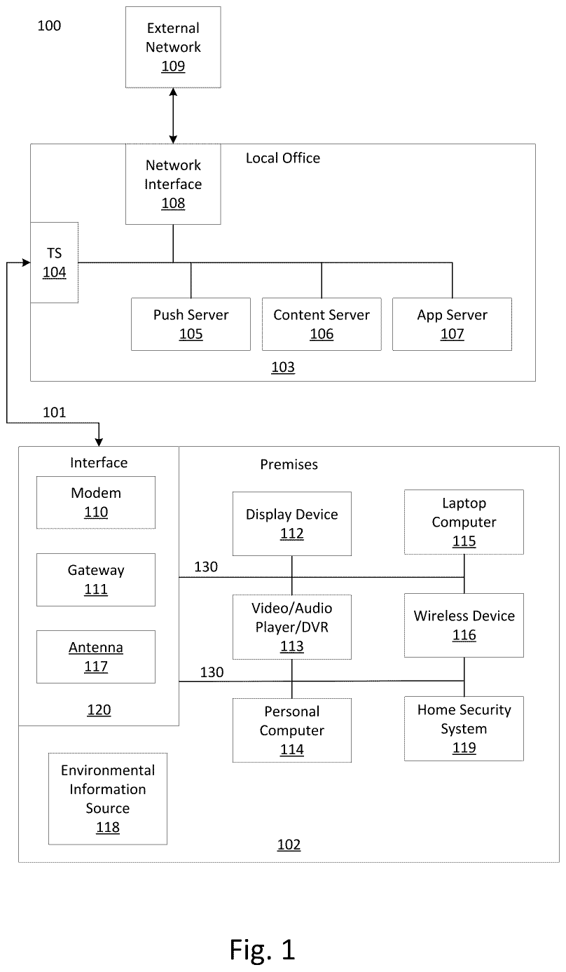

FIG. 1 shows an example communication network in which one or more of the various features described herein may be implemented. The communication network is only one example of a network and is not intended to suggest any limitation as to the scope of use or functionality of the disclosure. The communication network should not be interpreted as having any dependency or requirement relating to any component or combination of components in a communication network.

A network 100 may be a telecommunications network, a Multi-Service Operator (MSO) network, a cable television (CATV) network, a cellular network, a wireless network, an optical fiber network, a coaxial cable network, a Hybrid Fiber-Coaxial (HFC) network, or any other type of information distribution network or combination of networks. For example, the network 100 may be a cellular broadband network communicating with multiple communications access points, such as a wireless communications tower. The network 100 may be a coaxial system comprising a Cable Modem Termination System (CMTS) communicating with numerous gateway interface devices (e.g., a gateway 111 in a premises 102). The network 100 may be a fiber-optic system comprising optical fibers extending from an Optical Line Terminal (OLT) to numerous Optical Network Terminals (ONTs) communicatively coupled with various gateway interface devices. The network 100 may be a Digital Subscriber Line (DSL) system that includes a local office 103 communicating with numerous gateway interface devices. The network 100 may be an HFC network in which Internet traffic is routed over both optical and coaxial communication paths to a gateway interface device in or near a user's home. Various examples of the disclosure may operate on one or more of the networks described herein or any other network architectures now known or later developed.

The network 100 may use a series of interconnected communication links 101 (e.g., coaxial cables, optical fibers, wireless links, etc.) to connect a premises 102 (e.g., a home or other user environment) to the local office 103. The communication links 101 may include any wired communication links, wireless communication links, communications networks, or combinations thereof. For example, portions of the communication links 101 may be implemented with fiber-optic cable, while other portions of the communication links 101 may be implemented with coaxial cable. The communication links 101 may also include various communications components such as splitters, filters, amplifiers, wireless components, and other components for communicating data. Data may include, for example, Internet data, voice data, weather data, media content, and any other information. Media content may include, for example, video content, audio content, media on demand, video on demand, streaming video, television programs, text listings, graphics, advertisements, and other content. A media content item may represent an individual piece of media content, such as a particular movie, television episode, online video clip, song, audio recording, image, or any other data. A media content item may be fragmented into segments, such as a plurality of two-second video fragments that may be separately addressed and retrieved.

The local office 103 may transmit downstream information signals onto the communication links 101, and one or more of the premises 102 may receive and process those signals. In certain implementations, the communication links 101 may originate from the local office 103 as a single communications path, and may be split into any number of communication links to distribute data to the premises 102 and various other destinations. Although the term premises is used by way of example, the premises 102 may include any type of user environment, such as single-family homes, apartment complexes, businesses, schools, hospitals, parks, and other environments and combinations of environments.

The local office 103 may include a termination system 104, which may be a computing device configured to manage communications between devices on the network of the communication links 101 and backend devices, such as a server. For example, the termination system 104 may be a CMTS. The termination system 104 may be as specified in a standard, such as, in an example of an HFC-type network, the Data Over Cable Service Interface Specification (DOCSIS) standard, published by Cable Television Laboratories, Inc. The termination system 104 may be configured to transmit data over one or more downstream channels or frequencies to be received by various devices, such as modems in the premises 102, and to receive upstream communications from those modems on one or more upstream frequencies.

The local office 103 may include one or more network interfaces 108 for communicating with one or more external networks 109. The one or more external networks 109 may include, for example, one or more telecommunications networks, Internet Protocol (IP) networks, cellular communications networks (e.g., Global System for Mobile Communications (GSM), Code Division Multiple Access (CDMA), and any other 2nd, 3rd, 4th, or higher generation cellular communications networks), cellular broadband networks, radio access networks, fiber-optic networks, local wireless networks (e.g., Wi-Fi, WiMAX), satellite networks, and any other networks or combinations of networks.

The local office 103 may include a variety of servers that may be configured to perform various functions. The local office 103 may include a push server 105 for generating push notifications to deliver data, instructions, or both to devices that are configured to detect such notifications. The local office 103 may include a content server 106 configured to provide content (e.g., media content) to devices. The local office 103 may also include an application server 107.

The premises 102 may include an interface 120, which may include a modem 110 (or any device), for communicating on the communication links 101 with the local office 103, the one or more external networks 109, or both. For example, the modem 110 may be a coaxial cable modem (for coaxial cable links), a broadband modem (for DSL links), a fiber interface node (for fiber-optic links), or any other device or combination of devices. The modem 110 may be a part of, or communicatively coupled to, the gateway 111. The gateway 111 may be, for example, a wireless router, a video and/or audio player, a computer server, or any other computing device or combination.

The gateway 111 may be any computing device for communicating with the modem 110 to allow one or more other devices in the premises 102 to communicate with the local office 103, the one or more external networks 109, or other devices communicatively coupled thereto. The gateway 111 may include local network interfaces and an Ethernet connection 130 to provide communication signals to client devices in or near the premises 102, such as a display device 112 (such as a television, monitor, etc.), a video and/or audio player and/or digital video recorder (DVR) 113, a personal computer 114, a laptop computer 115, a wireless device 116 (e.g., a wireless laptop, a tablet computer, a mobile phone, a portable gaming device a vehicular computing system, a mobile computing system, a navigation system, an entertainment system in an automobile, marine vessel, aircraft, or the like), a home security system 119, or any other device.

One or more of the interface 120, the modem 110, and/or the gateway 111 may comprise a physical layer interface (PHY) rate associated with data traffic on the Ethernet connection 130. One or more of the interface 120, the modem 110, and/or the gateway 111 may comprise an Ethernet transmit buffer associated with data traffic on the Ethernet connection 130.

An interference detection device 117 may detect radio frequency (RF) interference and/or noise on the Ethernet connection 130. The interference detection device 117 may comprise one or more of a Wi-Fi antenna, a Bluetooth antenna, thermal sensor, magnetic sensor, electromagnetic sensor, and other sensors. As an example, the interference detection device 117 may be configured to detect the RF frequencies or harmonics of frequencies used over Ethernet (e.g., IEEE 802.3 standard). The interference detection device 117 may be integrated into one or more of the interface 120, the modem 110, and/or the gateway 111. The interference detection device 117 may be separate from the interface 120, the modem 110, and the gateway 111, and in communication with one or more of the interface 120, the modem 110, and/or the gateway 111.

The interference detection device 117 may be used alone or in conjunction with a heat detecting device, such as a thermistor and/or thermometer and/or a thermal image sensor and/or other such heat detecting technologies well-known to those familiar with the art. The heat detecting device may be used to detect excessive heat on and/or near the Ethernet connection 130. The interference detection device 117 may be used in conjunction with a magnetic field detecting device, such as a magnetometer. The magnetic field detecting device may be used to detect excessive magnetic fields on and/or near the Ethernet connection 130. Although the interference detection device 117 is shown integrated with the interface 120, the interference detection device 117, or other external source sensor, such as heat detecting device, magnetic field detecting device, static detecting device, etc. may be in another device, such as the display device 112, the video and/or audio player and/or digital video recorder (DVR) 113, the personal computer 114, the laptop computer 115, the wireless device 116, and/or the home security system 119.

An environmental information source 118 may provide interference and/or noise that causes errors for data traffic on the Ethernet connection 130. The environment information source 118 may be any source of excessive RF interference, heat, static energy, magnetic energy, or any environment information that may cause errors for data traffic on the Ethernet connection 130.

A first PHY rate associated with communication on the Ethernet connection 130 may be set at one or more of the interface 120, the modem 110, and/or the gateway 111. The first PHY rate may comprise 10 Gigabits per second (Gbps). An environmental information source 118 may emit RF signals. The environmental information source 118 may comprise a microwave, for example. The interference detection device 117 may detect the environmental information from the environmental information source 118. A determination may be made that the environmental information may interfere with communication on the Ethernet connection 130. In response to the detected environmental information, a second PHY rate associated with communication on the Ethernet connection 130 may be set at one or more of the interface 120, the modem 110, and/or the gateway 111. The second PHY rate may be less than the first PHY rate. The second PHY rate may comprise 500 Megabits per second (Mbps).

The environment information source 118 may discontinue emitting RF signals. The interference detection device 117 may no longer detect the environmental information from the environmental information source 118. In response to no longer detecting the environmental information, a third PHY rate associated with communication on the Ethernet connection 130 may be set at one or more of the interface 120, the modem 110, and/or the gateway 111. The third PHY rate may be greater than the second PHY rate. The third PHY rate may be the same as the first PHY rate. The third PHY rate may be less than the first PHY rate. The PHY rate may be incrementally increased, as long as no environmental information determined to likely interfere with the Ethernet connection 130 is detected, until the PHY rate is returned to the first PHY rate.

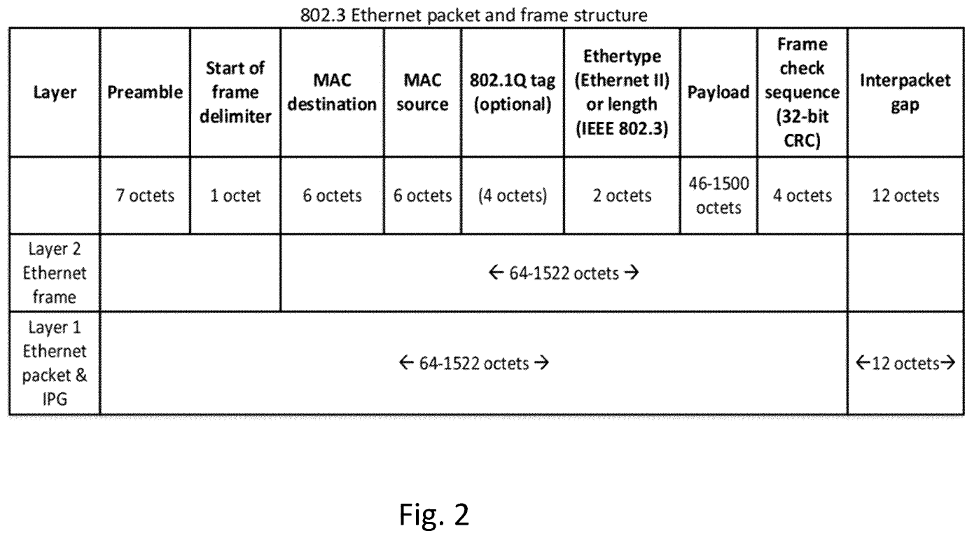

FIG. 2 shows an example of an Ethernet packet and frame structure. An Ethernet packet and frame structure may correspond with the Ethernet packet and frame structure for Institute of Electrical and Electronics Engineers (IEEE) 802.3. An Ethernet frame may be preceded by a preamble (e.g., 7 octets) and a start frame delimiter (SFD) (e.g., 1 octet), both of which may be part of an Ethernet packet at a physical layer. The Ethernet frame may start with an Ethernet header, which may comprise destination and/or source medium access control (MAC) addresses as two fields (e.g., 6 octets of MAC destination and 6 octets of MAC source). An optional 802.1Q tag (e.g., 4 octets) may follow the MAC addresses. Another field may comprise an Ethertype (e.g., in Ethernet II) or length (e.g., in IEEE 802.3) (e.g., 2 octets). Thereafter, a middle section of the frame may comprise payload data (e.g., 46-1500 octets), which may include, for example, any headers for other protocols (e.g., Internet Protocol (IP)) that may be carried in the frame. The frame may end with a frame check sequence (FCS) (e.g., 4 octets), which may comprise a 32-bit cyclic redundancy check that may be used to detect any in-transit corruption of data. An inter-packet gap (IPG) (e.g., 12 octets) may be provided at the end of the Ethernet packet. A layer 2 Ethernet frame may comprise 64 to 1522 octets after the preamble and the SFD. A layer 1 Ethernet packet may comprise 64 to 1522 octets including the preamble and the SFD, followed by an IPG of 12 octets.

The systems and methods described herein may detect issues with Ethernet frames. A value in the FCS field may indicate corruption of the Ethernet frame. The corruption may be due to interference in the Ethernet connection. If a value in the FCS field of an Ethernet frame indicates a data transmission error occurred, then a PHY rate associated with the Ethernet connection may be decreased, as long as a minimum PHY rate is not currently used. If a value in the FCS field of an Ethernet frame indicates a data transmission error occurred, then a transmit buffer associated with the Ethernet connection may be increased, as long as a maximum transmit buffer length is not currently being used.

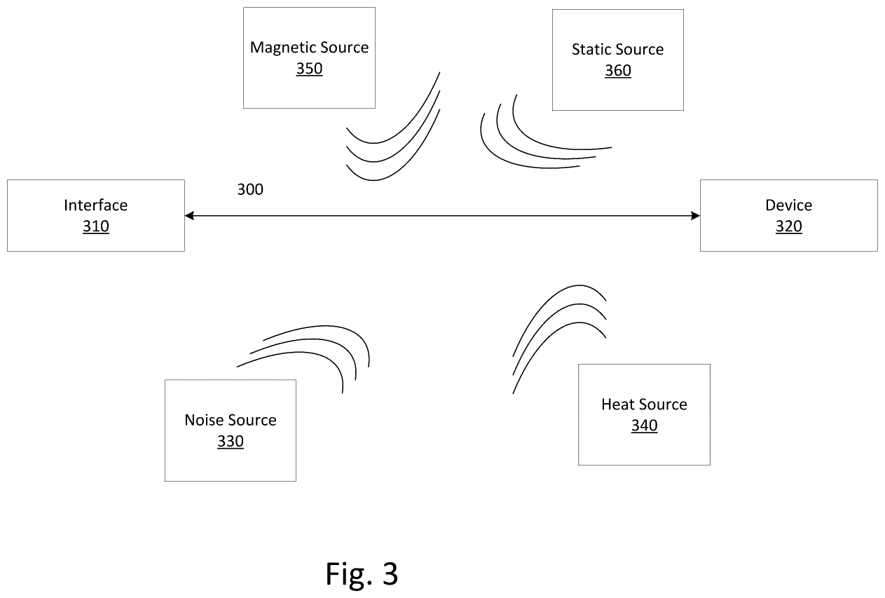

FIG. 3 shows an example network link (e.g., communication link, etc.). The network link comprises an interface 310 and a device 320 connected via an Ethernet connection 300. The interface 310 may comprise an interference detection device. The interface 310 may comprise the interface 120, modem 110, and/or gateway 111 of FIG. 1. The device 320 may comprise one or more of the display device 112, video and/or audio player and/or DVR 113, personal computer 114, laptop computer 115, wireless device 116, and/or home security system 119 in FIG. 1. The Ethernet connection 130 in FIG. 1 may comprise the Ethernet connection 300. Data may be transmitted between the interface 310 and the device 320 via the Ethernet connection 300.

Interference or noise may impact the signals over the Ethernet connection 300. As an example, cell phone or cell phone tower, or other radio transmitters may interfere with the signals over the Ethernet connection 300. As another example, an air conditioner or refrigerator compressor or pump may interfere with the signals over the Ethernet connection 300. Excess heat may interfere with the signals over the Ethernet connection 300. As an example, one or more devices being placed in entertainment or equipment cabinet with restricted air flow may cause heat. Electrostatic discharge may interfere with the signals over the Ethernet connection 300.

Data transmitted via the Ethernet connection 300 may be interfered with by external sources, such as a noise source 330, a heat source 340, a magnetic source 350, and a static energy source 360. The external sources may produce environmental conditions and/or environmental information. The noise source 330 may produce excessive radio frequency (RF) noise that may cause interference with data transmitted via the Ethernet connection 300. Examples of sources that could be the noise source 330 include a microwave oven. The heat source 340 may produce excessive thermal energy that may cause interference with data transmitted via the Ethernet connection 300. Examples of sources that could be the heat source 340 include a radiator, a hairdryer, and an electronic device. The magnetic source 350 may produce an excessive magnetic field that may cause interference with data transmitted via the Ethernet connection 300. Examples of sources that could be the magnetic source 350 include a refrigerator or a magnet. The static source 360 may produce excessive static energy that may cause interference with data transmitted via the Ethernet connection 300. Examples of sources that could be the static source 360 include lightning or discharge static from people or equipment.

The interface 310 may determine an external source has compromised data traffic on the Ethernet connection 300 by detecting environmental information (such as using an antenna to detect excessive RF interference or thermal sensor, magnetic sensor, electromagnetic sensor, and other sensors) or by determining that an Ethernet frame received via the Ethernet connection 300 is corrupted (e.g., is compromised, has an error, etc.). In response to determining that an external source has compromised data traffic on the Ethernet connection 300, the interface 310 may take corrective measures to protect the data on the Ethernet connection 300. Corrective measures may comprise decreasing the PHY rate associated with the Ethernet connection 300 from an original PHY rate to a lower PHY rate and/or increasing a transmit buffer size associated with the Ethernet connection 300 from an original transmit buffer size to a larger transmit buffer size. The interface 310 may detect environmental information via a sensor. The device 320 may detect environmental information via a sensor, such as an antenna, and transmit an indication of the detection to the interface 310.

The interface 310 may determine that the external source is no longer compromising data traffic on the Ethernet connection 300 by no longer detecting environmental information or by determining that Ethernet frames received via the Ethernet connection 300 are no longer corrupted. Determining that the external source is no longer compromised may include an amount of time passing with no environmental information of concern detected. Determining that the external source is no longer compromised may comprise receiving a number of Ethernet frames with no errors. Determining that the external source is no longer compromised may comprise an amount of time passing with no corrupted Ethernet frames received.

In response to determining that the external source is no longer compromising data traffic on the Ethernet connection 300, the interface 310 may remove and/or incrementally reduce the corrective measures taken. Removing the corrective measures may comprise returning the PHY rate associated with the Ethernet connection 300 to the original PHY rate and/or returning the transmit buffer size associated with the Ethernet connection 300 to the original transmit buffer size. Incrementally reducing the corrective measures may comprise increasing the PHY rate associated with the Ethernet connection 300 to a rate that is less than the original PHY rate and/or decreasing the transmit buffer size associated with the Ethernet connection 300 to a size that is smaller than the original transmit buffer size.

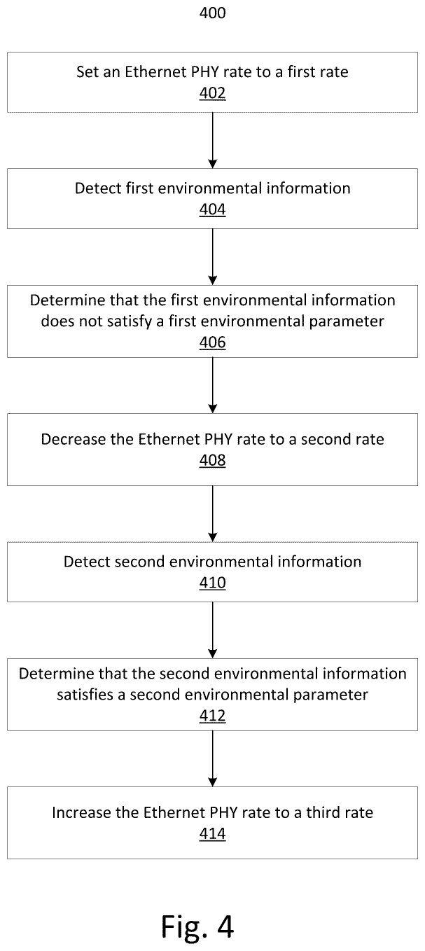

FIG. 4 shows a flowchart of an example process 400. In some implementations, one or more process blocks of FIG. 4 may be performed by the interface 120, the modem 110, and/or the gateway 111 in FIG. 1.

An Ethernet physical layer interface (PHY) rate may be set to a first rate (block 402). The interface 120, the modem 110, and/or the gateway 111 may set the Ethernet PHY rate to a first rate (speed, etc.). The Ethernet PHY rate may be associated with a network link. The network link may facilitate communication between a first computing device and a second computing device. The first computing device may comprise the interface 120, the modem 110, and/or the gateway 111. The second computing device may comprise the display device 112, the video/audio player and/or digital video recorder (DVR) 113, the personal computer 114, the laptop computer 115, the wireless device 116, and/or the home security system 119 in FIG. 1. The first rate may comprise 10 Gigabits per second (Gbps). The Ethernet PHY rate may determine a maximum speed data may be transmitted over the network link.

First environmental information may be detected (block 404). The interface 120, the modem 110, the gateway 111, and/or another sensing device, may detect the first environmental information. The first environmental information may comprise at least one of radio frequency (RF) noise or interference, static energy, heat energy, or a magnetic field. The first environmental information may be detected using an interference detection device (e.g., antenna, sensors). The interference detection device may comprise a thermal sensor, magnetic sensor, electromagnetic sensor, or other sensors. The interference detection device may comprise a Wi-Fi antenna. The interference detection device may comprise a Bluetooth antenna. The interface 120, the modem 110, and/or the gateway 111 may comprise the interference detection device. The display device 112, the video and/or audio player and/or digital video recorder (DVR) 113, the personal computer 114, the laptop computer 115, the wireless device 116, and/or the home security system 119 may comprise the interference detection device.

A determination may be made that the first environmental information does not satisfy a first environmental (telemetry, etc.) parameter (threshold, metric, condition, state, etc.) (block 406). The interface 120, the modem 110, and/or the gateway 111 may determine that the first environmental information does not satisfy the first environmental parameter. The first environmental parameter may comprise a band associated with an Institute of Electrical and Electronics Engineers (IEEE) 802.3 standard, or a harmonic of said band. The first environmental parameter may comprise a frequency parameter (threshold, metric, condition, state, etc.) and an amplitude parameter (threshold, metric, condition, state, etc.). The amplitude parameter may be dependent on the frequency parameter. The frequency parameter may comprise 800 Mega Hertz (MHz) or a harmonic of 800 MHz.

The Ethernet PHY rate may be decreased to a second rate (block 408). The interface 120, the modem 110, and/or the gateway 111 may decrease the Ethernet PHY rate to a second rate. The Ethernet PHY rate may be decreased to the second rate in response to the determination that the first environment information does not satisfy the first environmental parameter. The second rate may comprise 500 Megabits per second (Mbps). A size of a transmit buffer may be increased. The interface 120, the modem 110, and/or the gateway 111 may increase the size of the transmit buffer. Decreasing the Ethernet PHY rate may decrease a maximum speed at which data may be transmitted over the network link. Decreasing the Ethernet PHY rate may reduce errors in data transmitted over the network link. Decreasing the Ethernet PHY rate may increase reliability of data transmitted over the network link. Decreasing the Ethernet PHY rate may comprise adjusting modulation associated with the network link. Decreasing the Ethernet PHY rate may comprise adjusting a send rate associated with the network link. Decreasing the Ethernet PHY rate may comprise adjusting a receive rate associated with the network link.

Second environmental information may be detected (block 410). The interface 120, the modem 110, and/or the gateway 111 may detect the second environmental information. The second environmental information may comprise at least one of radio frequency (RF) interference, static energy, heat energy, or a magnetic field. The second environmental information may be detected using an interference detection device (e.g., an antenna or sensor). The interference detection device may comprise a thermal sensor, magnetic sensor, electromagnetic sensor, or other sensors. The interference detection device may comprise a Wi-Fi antenna. The interference detection device may comprise a Bluetooth antenna. The interface 120, the modem 110, and/or the gateway 111 may comprise the interference detection device. The display device 112, the video and/or audio player and/or digital video recorder (DVR) 113, the personal computer 114, the laptop computer 115, the wireless device 116, and/or the home security system 119 may comprise the interference detection device.

A determination may be made that the second environmental information satisfies a second environmental parameter (block 412). The interface 120, the modem 110, and/or the gateway 111 may determine that the second environmental information satisfies the second environmental parameter. The second environmental parameter may be the same as the first environmental parameter. The second environmental parameter may be different from the first environmental parameter. The second environmental parameter may comprise a band associated with an Institute of Electrical and Electronics Engineers (IEEE) 802.3 standard, or a harmonic of said band. The second environmental parameter may comprise a frequency parameter and an amplitude parameter. The amplitude parameter may be dependent on the frequency parameter. The frequency parameter may comprise 800 Mega Hertz (MHz), or a harmonic of 800 MHz.

The Ethernet PHY rate may be increased to a third rate (block 414). The interface 120, the modem 110, and/or the gateway 111 may increase the Ethernet PHY rate to a third rate. The Ethernet PHY rate may be increased to the third rate in response to the determination that the second environment information satisfies the second environmental parameter. The third rate may be the same as the first rate. The third rate may be less than the first rate. The third rate may comprise 1 Gbps. The size of the transmit buffer may be decreased. The interface 120, the modem 110, and/or the gateway 111 may decrease the size of the transmit buffer. Increasing the Ethernet PHY rate may increase a maximum speed at which data may be transmitted over the network link. Increasing the Ethernet PHY rate may comprise adjusting modulation associated with the network link. Increasing the Ethernet PHY rate may comprise adjusting a send rate associated with the network link. Increasing the Ethernet PHY rate may comprise adjusting a receive rate associated with the network link.

Although example blocks are shown, some implementations may include additional blocks, fewer blocks, different blocks, or differently arranged blocks than those depicted. Additionally, or alternatively, two or more of the blocks may be performed in parallel.

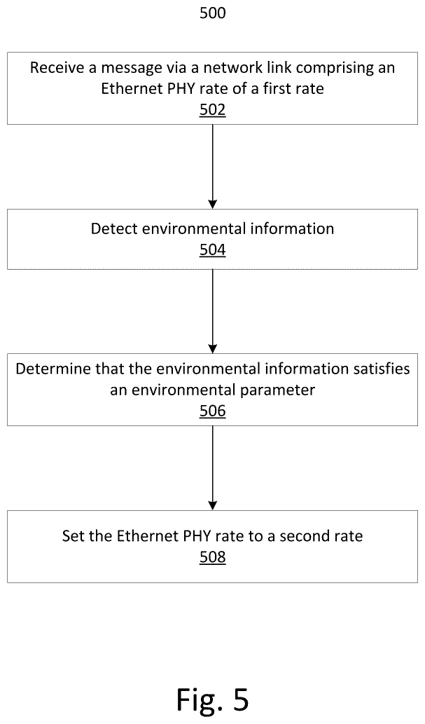

FIG. 5 shows a flowchart of an example process 500. In some implementations, one or more process blocks of FIG. 5 may be performed by the interface 120, the modem 110, and/or the gateway 111 in FIG. 1.

A message may be received via a network link comprising an Ethernet PHY rate of a first rate (block 502). The interface 120, the modem 110, and/or the gateway 111 may receive the message via the network link comprising the Ethernet PHY rate of the first rate. The first rate may comprise 1 Gigabit per second (Gbps). Other rates may be used. The network link may facilitate communication between a first computing device and a second computing device. The first computing device may comprise the interface 120, the modem 110, and/or the gateway 111. The second computing device may comprise the display device 112, the video and/or audio player and/or digital video recorder (DVR) 113, the personal computer 114, the laptop computer 115, the wireless device 116, and/or the home security system 119 in FIG. 1. The Ethernet PHY rate may determine a maximum speed data may be transmitted over the network link.

Environmental information may be detected (block 504). The interface 120, the modem 110, and/or the gateway 111 may detect the environmental information. The environmental information may comprise at least one of radio frequency (RF) interference, static energy, heat energy, or a magnetic field. The environmental information may be detected using an interference detection device (e.g., an antenna or sensor). The interference detection device may comprise a thermal sensor, magnetic sensor, electromagnetic sensor, or other sensors. The interference detection device may comprise a Wi-Fi antenna. The interference detection device may comprise a Bluetooth antenna. The interface 120, the modem 110, and/or the gateway 111 may comprise the interference detection device. The display device 112, the video and/or audio player and/or digital video recorder (DVR) 113, the personal computer 114, the laptop computer 115, the wireless device 116, and/or the home security system 119 may comprise the interference detection device.

A determination may be made that the environmental information satisfies an environmental parameter (block 506). The interface 120, the modem 110, and/or the gateway 111 may determine that the environmental information satisfies the environmental parameter. The environmental parameter may comprise a band associated with an Institute of Electrical and Electronics Engineers (IEEE) 802.3 standard, or a harmonic of said band. The environmental parameter may comprise a frequency parameter and an amplitude parameter. The amplitude parameter may be dependent on the frequency parameter. The frequency parameter may comprise 800 Mega Hertz (MHz), or a harmonic of 800 MHz.

The Ethernet PHY rate may be set to a second rate (block 508). The interface 120, the modem 110, and/or the gateway 111 may set the Ethernet PHY rate to a second rate. The Ethernet PHY rate may be set to the second rate in response to the determination that the environment information satisfies the environmental parameter. The second rate may be greater than the first rate. The second rate may comprise 2 Gbps. Other rates may be used. A size of a transmit buffer may be decreased. The interface 120, the modem 110, and/or the gateway 111 may decrease the size of the transmit buffer.

Setting the Ethernet PHY rate to a higher rate may increase a maximum speed at which data may be transmitted over the network link. Setting the Ethernet PHY rate to a higher rate may comprise adjusting modulation associated with the network link. Setting the Ethernet PHY rate to a higher rate may comprise adjusting a send rate associated with the network link. Setting the Ethernet PHY rate to a higher rate may comprise adjusting a receive rate associated with the network link.

Although example blocks are shown, some implementations may include additional blocks, fewer blocks, different blocks, or differently arranged blocks than those depicted. Additionally, or alternatively, two or more of the blocks may be performed in parallel.

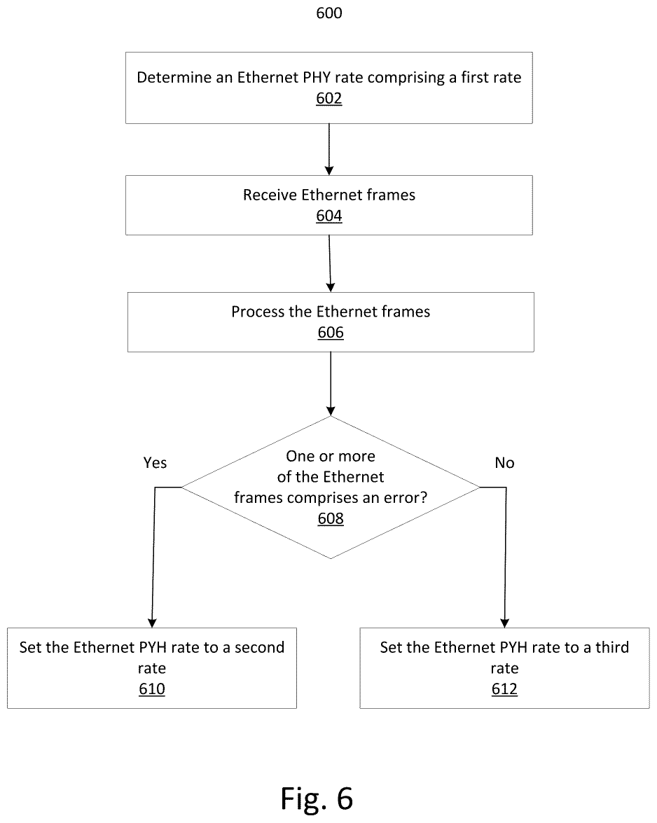

FIG. 6 shows a flowchart of an example process 600. In some implementations, one or more process blocks of FIG. 6 may be performed by the interface 120, the modem 110, and/or the gateway 111 in FIG. 1.

An Ethernet PHY rate comprising a first rate may be determined (block 602). The interface 120, the modem 110, and/or the gateway 111 may determine the Ethernet PHY rate comprising a first rate. The Ethernet PHY rate may be associated with a network link. Determining the Ethernet PHY rate may comprise setting the Ethernet PHY rate to the first rate. The interface 120, the modem 110, and/or the gateway 111 may set the Ethernet PHY rate to the first rate. The network link facilitates communication between a first computing device and a second computing device. The first computing device may comprise the interface 120, the modem 110, and/or the gateway 111. The second computing device may comprise the display device 112, the video and/or audio player and/or digital video recorder (DVR) 113, the personal computer 114, the laptop computer 115, the wireless device 116, and/or the home security system 119 in FIG. 1. The first rate may comprise 5 Gigabits per second (Gbps). Other rates may be used. The Ethernet PHY rate may determine a maximum speed data may be transmitted over the network link.

Ethernet frames may be received (block 604). The interface 120, the modem 110, and/or the gateway 111 may receive Ethernet frames. The Ethernet frames may be received via the network link.

The Ethernet frames may be processed (block 606). The interface 120, the modem 110, and/or the gateway 111 may process the Ethernet frames.

A determination may be made of if one or more of the Ethernet frames comprises an error (block 608). The interface 120, the modem 110, and/or the gateway 111 may make the determination of if one or more of the Ethernet frames comprises an error. The determination may comprise making a determination of if the one or more of the Ethernet frames is corrupted by at least one of radio frequency (RF) interference, static energy, heat energy, or a magnetic field. The determination may comprise determining if the one or more of the Ethernet frames is corrupted by radio frequency (RF) interference on a band associated with an Institute of Electrical and Electronics Engineers (IEEE) 802.3 standard, or a harmonic of said bands.

The determination may comprise comprises determining if the one of the Ethernet frames is corrupted by radio frequency (RF) interference comprising a frequency parameter and an amplitude parameter. The amplitude parameter may be dependent on the frequency parameter. The frequency parameter may comprise 800 Mega Hertz (MHz). The determination may comprise using an interference detection device. The interference detection device may comprise a thermal sensor, magnetic sensor, electromagnetic sensor, or other sensors. The interference detection device may comprise a Wi-Fi antenna. The interference detection device may comprise a Bluetooth antenna. The interface 120, the modem 110, and/or the gateway 111 may comprise the interference detection device. The display device 112, the video and/or audio player and/or digital video recorder (DVR) 113, the personal computer 114, the laptop computer 115, the wireless device 116, and/or the home security system 119 may comprise the interference detection device.

The Ethernet PHY rate may be set to a second rate (block 610). The interface 120, the modem 110, and/or the gateway 111 may set the Ethernet PHY rate to the second rate. The Ethernet PHY rate may be set to the second rate in response to determining that the one of the Ethernet frames comprises an error. The Ethernet PHY rate may be set to the second rate if the Ethernet PHY rate is not at a minimum PHY rate. The second rate may be less than the first rate. The second rate may comprise 1 Gigabit per second (Gbps). Other rate may be used. A size of a transmit buffer may be increased. The interface 120, the modem 110, and/or the gateway 111 may increase the size of the transmit buffer.

Setting the Ethernet PHY rate to a lower rate may decrease a maximum speed at which data may be transmitted over the network link. Setting the Ethernet PHY rate to a lower rate may reduce errors in data transmitted over the network link. Setting the Ethernet PHY rate to a lower rate may increase reliability of data transmitted over the network link. Setting the Ethernet PHY rate to a lower rate may comprise adjusting modulation associated with the network link. Setting the Ethernet PHY rate to a lower rate may comprise adjusting a send rate associated with the network link. Setting the Ethernet PHY rate to a lower rate may comprise adjusting a receive rate associated with the network link.

The Ethernet PHY rate may be set to a third rate (block 612). The interface 120, the modem 110, and/or the gateway 111 may set the Ethernet PHY rate to the third rate. The Ethernet PHY rate may be set to the third rate in response to determining that the one of the Ethernet frames does not comprise an error. The Ethernet PHY rate may be set to the third rate if the Ethernet PHY rate is not at a maximum PHY rate. The third rate may be greater than the first rate. The third rate may comprise 10 Gigabits per second (Gbps). A size of a transmit buffer may be decreased. The interface 120, the modem 110, and/or the gateway 111 may decrease the size of the transmit buffer.

Setting the Ethernet PHY rate to a higher rate may increase a maximum speed at which data may be transmitted over the network link. Setting the Ethernet PHY rate to a higher rate may comprise adjusting modulation associated with the network link. Setting the Ethernet PHY rate to a higher rate may comprise adjusting a send rate associated with the network link. Setting the Ethernet PHY rate to a higher rate may comprise adjusting a receive rate associated with the network link.

Although example blocks are shown, some implementations may include additional blocks, fewer blocks, different blocks, or differently arranged blocks than those depicted. Additionally, or alternatively, two or more of the blocks may be performed in parallel.

### EXAMPLES

Example Clause 1: A method may include: setting, by a first computing device, an Ethernet physical layer interface (PHY) rate associated with a network link to a first rate; detecting first environmental information; determining, at the first computing device, that the first environmental information does not satisfy a first environmental parameter; decreasing, at the first computing device, the Ethernet PHY rate to a second rate in response to the determining that the first environmental information does not satisfy the first environmental parameter; detecting second environmental information; determining, at the first computing device, that the second environmental information satisfies a second environmental parameter; and increasing, at the first computing device, the Ethernet PHY rate to a third rate in response to the determining that the second environmental information satisfies the second environmental parameter.

Example Clause 2: The method of Example Clause 1, where at least one of the first environmental information and the second environmental information may include at least one of radio frequency (RF) interference, static energy, heat energy, or a magnetic field.

Example Clause 3: The method of Example Clause 1 or Example Clause 2, where at least one of the first environmental information and the second environmental information may include radio frequency (RF) interference and at least one of the first environmental parameter and the second environmental parameter may include a band associated with an Institute of Electrical and Electronics Engineers (IEEE) 802.3 standard.

Example Clause 4: The method of any one of Example Clauses 1-3, where at least one of the first environmental information and the second environmental information may include radio frequency (RF) interference and at least one of the first environmental parameter and the second environmental parameter may include a frequency parameter and an amplitude parameter.

Example Clause 5: The method of any one of Example Clauses 1-4, where the amplitude parameter is dependent on the frequency parameter.

Example Clause 6: The method of any one of Example Clauses 1-5, where the frequency parameter may include 800 Mega Hertz (MHz).

Example Clause 7: The method of any one of Example Clauses 1-6, where the first rate may include 10 Gigabits per second (Gbps).

Example Clause 8: The method of any one of Example Clauses 1-7, where the second rate may include 500 Megabits per second (Mbps).

Example Clause 9: The method of any one of Example Clauses 1-8, where the third rate may include 1 Gbps.

Example Clause 10: The method of any one of Example Clauses 1-9, where the decreasing the Ethernet PHY rate to the second rate further may include increasing a size of a transmit buffer.

Example Clause 11: The method of any one of Example Clauses 1-10, where the increasing the Ethernet PHY rate to the third rate further may include decreasing the size of the transmit buffer.

Example Clause 12: The method of any one of Example Clauses 1-11, where the network link facilitates communication between the first computing device and a second computing device.

Example Clause 13: The method of any one of Example Clauses 1-12, where at least one of the detecting first environmental information or the detecting second environmental information may include using an interference detection device.

Example Clause 14: The method of any one of Example Clauses 1-13, where the first computing device may include the interference detection device.

Example Clause 15: The method of any one of Example Clauses 1-14, where a second computing device may include the interference detection device.

Example Clause 16: A method may include: Receiving, by a first computing device, a message via a network link may include an Ethernet physical layer interface (PHY) rate of a first rate; detecting environmental information; determining, by the first computing device, that the environmental information satisfies an environmental parameter; and setting, by the first computing device, the Ethernet PHY rate to a second rate in response to the determining that the environmental information satisfies the environmental parameter, where the second rate is greater than the first rate.

Example Clause 17: The method of Example Clause 16, where the environmental information may include at least one of radio frequency (RF) interference, static energy, heat energy, or a magnetic field.

Example Clause 18: The method of Example Clause 16 or Example Clause 17, where the environmental information may include radio frequency (RF) interference and the environmental parameter may include a band associated with an Institute of Electrical and Electronics Engineers (IEEE) 802.3 standard.

Example Clause 19: The method of any one of Example Clauses 16-18, where the environmental information may include radio frequency (RF) interference and the environmental parameter may include a frequency parameter and an amplitude parameter.

Example Clause 20: The method of any one of Example Clauses 16-19, where the amplitude parameter is dependent on the frequency parameter.

Example Clause 21: The method of any one of Example Clauses 16-20, where the frequency parameter may include 800 Mega Hertz (MHz).

Example Clause 22: The method of any one of Example Clauses 16-21, where the first rate may include 1 Gigabit per second (Gbps).

Example Clause 23: The method of any one of Example Clauses 16-22, where the second rate may include 2 Gbps.

Example Clause 24: The method of any one of Example Clauses 16-23, where the setting the Ethernet PHY rate to the second rate further may include decreasing a size of a transmit buffer.

Example Clause 25: The method of any one of Example Clauses 16-24, where the network link facilitates communication between the first computing device and a second computing device.

Example Clause 26: The method of any one of Example Clauses 16-25, where the detecting environmental information may include using an interference detection device.

Example Clause 27: The method of any one of Example Clauses 16-26, where the first computing device may include the interference detection device.

Example Clause 28: The method of any one of Example Clauses 16-27, where a second computing device may include the interference detection device.

Example Clause 29: A method may include: determining, by a first computing device, an Ethernet physical layer interface (PHY) rate associated with a network link, where the determining the Ethernet PHY rate may include setting the Ethernet PHY rate to a first rate; receiving, by the first computing device, Ethernet frames via the network link; processing, by the first computing device, the Ethernet frames; determining, by the first computing device, if one of the Ethernet frames may include an error; in response to determining that the one of the Ethernet frames may include an error, if the Ethernet PHY rate is not at a minimum PHY rate, setting, by the first computing device, the Ethernet PHY rate to a second rate, where the second rate is less than the first rate; and in response to determining that the one of the Ethernet frames does not may include an error, if the Ethernet PHY rate is not at a maximum PHY rate, setting, by the first computing device, the Ethernet PHY rate to a third rate, where the third rate is greater than the first rate.

Example Clause 30: The method of Example Clause 29, where the determining if one of the Ethernet frames may include an error may include determining if the one of the Ethernet frames is corrupted by at least one of radio frequency (RF) interference, static energy, heat energy, or a magnetic field.

Example Clause 31: The method of Example Clause 29 or Example Clause 30, where the determining if one of the Ethernet frames may include an error may include determining if the one of the Ethernet frames is corrupted by radio frequency (RF) interference on a band associated with an Institute of Electrical and Electronics Engineers (IEEE) 802.3 standard.

Example Clause 32: The method of any one of Example Clauses 29-31, where the determining if one of the Ethernet frames may include an error may include determining if the one of the Ethernet frames is corrupted by radio frequency (RF) interference may include a frequency parameter and an amplitude parameter.

Example Clause 33: The method of any one of Example Clauses 29-32, where the amplitude parameter is dependent on the frequency parameter.

Example Clause 34: The method of any one of Example Clauses 29-33, where the frequency parameter may include 800 Mega Hertz (MHz).

Example Clause 35: The method of any one of Example Clauses 29-34, where the first rate may include 5 Gigabits per second (Gbps).

Example Clause 36: The method of any one of Example Clauses 29-35, where the second rate may include 1 Gbps.

Example Clause 37: The method of any one of Example Clauses 29-36, where the third rate may include 10 Gbps.

Example Clause 38: The method of any one of Example Clauses 29-37, where the setting the Ethernet PHY rate to the second rate further may include increasing a size of a transmit buffer.

Example Clause 39: The method of any one of Example Clauses 29-38, where the setting the Ethernet PHY rate to the third rate further may include decreasing the size of the transmit buffer.

Example Clause 40: The method of any one of Example Clauses 29-39, where the network link facilitates communication between the first computing device and a second computing device.

Example Clause 41: The method of any one of Example Clauses 29-40, where the determining if one of the Ethernet frames may include an error may include using an interference detection device to determine radio frequency (RF) interference.

Example Clause 42: The method of any one of Example Clauses 29-41, where the first computing device may include the interference detection device.

Example Clause 43: The method of any one of Example Clauses 29-42, where a second computing device may include the interference detection device.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein. As used herein, satisfying a parameter (threshold, metric, condition, state, etc.) may, depending on the context, refer to a value being greater than the parameter, greater than or equal to the parameter, less than the parameter, less than or equal to the parameter, equal to the parameter, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
setting, by a first computing device, an Ethernet physical layer interface (PHY) rate associated with a network link to a first rate;
detecting first environmental information;
determining, at the first computing device, that the first environmental information does not satisfy a first environmental parameter;
decreasing, at the first computing device, the Ethernet PHY rate to a second rate in response to the determining that the first environmental information does not satisfy the first environmental parameter;
detecting second environmental information;
determining, at the first computing device, that the second environmental information satisfies a second environmental parameter; and
increasing, at the first computing device, the Ethernet PHY rate to a third rate in response to the determining that the second environmental information satisfies the second environmental parameter.

2. The method of claim 1, wherein at least one of the first environmental information and the second environmental information comprises at least one of radio frequency (RF) interference, static energy, heat energy, or a magnetic field.

3. The method of claim 1, wherein at least one of the first environmental information and the second environmental information comprises radio frequency (RF) interference and at least one of the first environmental parameter and the second environmental parameter comprises a band associated with an Institute of Electrical and Electronics Engineers (IEEE) 802.3 standard.

4. The method of claim 1, wherein at least one of the first environmental information and the second environmental information comprises radio frequency (RF) interference and at least one of the first environmental parameter and the second environmental parameter comprises a frequency parameter and an amplitude parameter.

5. The method of claim 4, wherein the amplitude parameter is dependent on the frequency parameter.

6. The method of claim 4, wherein the frequency parameter comprises 800 Mega Hertz (MHz).

7. The method of claim 1, wherein the first rate comprises 10 Gigabits per second (Gbps).

8. The method of claim 7, wherein the second rate comprises 500 Megabits per second (Mbps).

9. The method of claim 8, wherein the third rate comprises 1 Gbps.

10. The method of claim 1, wherein the decreasing the Ethernet PHY rate to the second rate further comprises increasing a size of a transmit buffer.

11. The method of claim 10, wherein the increasing the Ethernet PHY rate to the third rate further comprises decreasing the size of the transmit buffer.

12. The method of claim 1, wherein the network link facilitates communication between the first computing device and a second computing device.

13. The method of claim 1, wherein at least one of the detecting first environmental information or the detecting second environmental information comprises using an interference detection device.

14. The method of claim 13, wherein the first computing device comprises the interference detection device.

15. The method of claim 13, wherein a second computing device comprises the interference detection device.

16. A method comprising:
receiving, by a first computing device, a message via a network link comprising an Ethernet physical layer interface (PHY) rate of a first rate;
detecting environmental information;
determining, by the first computing device, that the environmental information satisfies an environmental parameter; and
setting, by the first computing device, the Ethernet PHY rate to a second rate in response to the determining that the environmental information satisfies the environmental parameter, wherein the second rate is greater than the first rate.

17. The method of claim 16, wherein the environmental information comprises at least one of radio frequency (RF) interference, static energy, heat energy, or a magnetic field.

18. The method of claim 16, wherein the environmental information comprises radio frequency (RF) interference and the environmental parameter comprises a band associated with an Institute of Electrical and Electronics Engineers (IEEE) 802.3 standard.

19. The method of claim 16, wherein the environmental information comprises radio frequency (RF) interference and the environmental parameter comprises a frequency parameter and an amplitude parameter.

20. The method of claim 16, wherein the setting the Ethernet PHY rate to the second rate further comprises decreasing a size of a transmit buffer.

21. A method comprising:
determining, by a first computing device, an Ethernet physical layer interface (PHY) rate associated with a network link, wherein the determining the Ethernet PHY rate comprises setting the Ethernet PHY rate to a first rate;
receiving, by the first computing device, Ethernet frames via the network link;
processing, by the first computing device, the Ethernet frames;
determining, by the first computing device, if one of the Ethernet frames comprises an error;
in response to determining that the one of the Ethernet frames comprises an error, if the Ethernet PHY rate is not at a minimum PHY rate, setting, by the first computing device, the Ethernet PHY rate to a second rate, wherein the second rate is less than the first rate; and
in response to determining that the one of the Ethernet frames does not comprise an error, if the Ethernet PHY rate is not at a maximum PHY rate, setting, by the first computing device, the Ethernet PHY rate to a third rate, wherein the third rate is greater than the first rate.

22. The method of claim 21, wherein the determining if one of the Ethernet frames comprises an error comprises determining if the one of the Ethernet frames is corrupted by at least one of radio frequency (RF) interference, static energy, heat energy, or a magnetic field.

23. The method of claim 21, wherein the determining if one of the Ethernet frames comprises an error comprises determining if the one of the Ethernet frames is corrupted by radio frequency (RF) interference on a band associated with an Institute of Electrical and Electronics Engineers (IEEE) 802.3 standard.

24. The method of claim 21, wherein the determining if one of the Ethernet frames comprises an error comprises determining if the one of the Ethernet frames is corrupted by radio frequency (RF) interference comprising a frequency parameter and an amplitude parameter.
